(19) United States
(12) Patent Application Publication
(10) Pub. No.: US 2010/0123993 A1
(43) Pub. Date: May 20, 2010

(54) ATOMIC LAYER DEPOSITION PROCESS FOR MANUFACTURE OF BATTERY ELECTRODES, CAPACITORS, RESISTORS, AND CATALYZERS

(76) Inventor: Herzel Laor, Boulder, CO (US)

Correspondence Address: SHERIDAN ROSS PC, 1560 BROADWAY, SUITE 1200, DENVER, CO, 80202, US

(21) Appl. No.: 12/370,394

(22) Filed: Feb. 12, 2009

Related U.S. Application Data
(60) Provisional application No. 61/028,383, filed on Feb. 13, 2008.
(60) Provisional application No. 61/028,402, filed on Feb. 13, 2008.

(51) Int. Cl. H01G 4/005; H01M 4/00; B05D 5/12; B01J 35/10

(52) U.S. Cl. 361/303; 429/209; 427/79; 502/100

(57) ABSTRACT

The present disclosure relates generally to the field of sequential surface chemistry. More specifically, it relates to products and methods for manufacturing products using Atomic Layer Deposition (“ALD”) to depose one or more materials onto a surface. ALD is an emerging variant of Chemical Vapor Deposition (“CVD”) technology with capability for high-quality film deposition at low pressures and temperatures, which may produce defect-free films, on a macroscopic scale, at any given thickness. The present disclosure includes, in varying embodiments, methods of manufacturing microelectronic assemblies and components such as battery electrodes, capacitors, resistors, catalyzers and PCB assemblies by ALD, and the products manufactured by those methods.

### CROSS REFERENCE TO RELATED APPLICATIONS

The present application claims the benefit of U.S. Provisional Patent Application Nos. 61/028,383 and 61/028,402, both filed Feb. 13, 2008, the entire contents of which are incorporated herein by reference.

### BACKGROUND OF THE INVENTION

The present invention relates generally to the field of sequential surface chemistry. More specifically, it relates to products and methods for manufacturing products using Atomic Layer Deposition (“ALD”) to depose one or more materials onto a surface. ALD is considered by some to be a variant of Chemical Vapor Deposition (“CVD”) technology, but with improved capability for high-quality, atomic-scale film depositions at low temperatures. The ALD technology was developed in part for the purposes of targeting deposition of materials for Silicon integrated circuit (“IC”) production. ALD is a relatively new method of Silicon IC manufacturing. ALD technology is highly efficient and may be enabled for use in applications other then Silicon IC manufacturing. See Appendix A to the U.S. Provisional Application Nos. 61/028,383 and 61/028,402 for details related to ALD technology, the contents of which are incorporated by reference herein in their entirety.

The CVD process is useful in quickly forming chemical layers on a substrate surface, such as an electrode. However, the non-uniformity of the layers deposited on the substrate can lead to voids, thereby rendering the electrode or other electrical component inoperable. In addition, while CVD coats the exposed surface of the substrate, ALD is penetrating, and will coat conformal, equal thickness layers on both exposed and hidden surfaces, due to the self-limiting properties of the ALD process.

Thus, there is a need for a improved method of manufacturing microelectronic assemblies such as battery electrodes, capacitors, resistors, and other PCB assemblies that overcomes the foregoing problems and also produces a component that is less expensive to manufacture and more efficient due to decrease in size and improved reliability. Various embodiments of the present invention address these needs.

### SUMMARY

Uniquely, ALD produces truly defect-free films, on a macroscopic scale, at any given thickness. ALD, in this sense, may be viewed as a substitute to CVD in the deposition of high-quality, dielectric layers on Silicon ICs. For example, a Layer of Al₂O₃ with 10 nm thickness may be deposited in under 20 minutes and achieve 0.7 μF/cm² at a breakdown voltage of 10V. The deposition temperature in the range of 100-200° C. is compatible with FR4 and Polyimide (Kapton®) PCB (Printed Circuit Board) materials. Al₂O₃ films are compatible with conventional PCB materials and manufacturing process flow.

Moor's Law for passive components for PCB assemblies has become saturated, with passives as small as 0201 (0.5*0.25 mm²) available and in use now. The size limitation is due to the limited capabilities of the equipment used for PCB assembly, namely pick-and-place tools. (See www.nemi.org/roadmapping/Executive_Summary.pdf, which is incorporated by reference in its entirety.) To further decrease the size of electronic assemblies, there is a need to integrate the passives into the PCB or the chip carrier. Use of deposited capacitors and resistors are common on ceramic substrates, due to the ability to fire insulators and conductors at high temperatures. There are several technologies that are now in research for PCB applications including sputtering, plating and CVD for creating thin films insulators and conductors. However, dielectric films have been difficult to manufacture on PCBs due to the temperature limitation of about 250° C. of FR4 and Polyimid. Some emerging technologies may enable deposition of insulating materials that achieve 0.1-0.2 μF/cm² capacity. However, none of these technologies has been perfected in the PCB manufacturing field. Once integrated capacitors reach the 0.1 μF/cm² mark, most capacitors on a PCB would be replaced. Thus, there is a current need in the art of electronics to improve on limitations with current pick-and-place assembly equipment, and to remove constraints on current limitations of electronic components and sub-components.

ALD manufacturing technology is developed to a high level, with deposition equipment available from several companies. See, e.g. http://en.wikipedia.org/wiki/Atomic_layer_deposition, www.beneq.com, www.oxford-instruments.com, www.cambridgenanotech.com, www.sundewtech.com, which are incorporated by reference in their entirety. Observing ALD-manufactured capacitors on Silicon substrates further demonstrates the benefits over other known manufacturing methods. For example, deposited Al₂O₃ forms a high quality layer of amorphous material on almost any material. More particularly, ALD dielectric films are exceptionally defect free, stress free and pinhole free down to the 1-2 monolayers thickness (0.6-0.8 nm). This unmatched characteristic is due to the unique, layer-by-layer growth mechanism of ALD films. Metal pads that are commonly utilized in the PCB manufacturing technology are (comparatively) highly irregular, porous and defected on a microscopic scale. Using ALD technology overcomes such deficiencies in part by the ability to conform to difficult topologies (of the underlying material). This is in contrast to sputtered or CVD dielectric films that have particular difficulties at creating uniform low thicknesses.

The tolerance in capacitance of the ALD deposited capacitor will depend in part on the tolerance of the metal patterning. This is due to the high accuracy in thickness of the ALD dielectric layer. Thickness variations are below 1% standard deviation and under 4% peak-to-peak. Thus, uniformity of thickness of the ALD layered material and improved surface consistency also leads to improved performance of the microelectronic component.

In addition to deposition on PCB materials, ALD technology may also be used for deposition of capacitors on chip carriers. This will enable construction of high capacitance, low inductance and low resistance bypass capacitors very near to the chip itself. The bypassing performance will substantially improve in part due to the short distance between the chip and the capacitor, and in part due to the lower inductance of the capacitor itself.

By way of example but not limitation, a Nokia 6161 cell-phone has 232 Capacitors, 149 Resistors and 24 inductors on a PCB of approximately 40 cm². (See Putting Passives in their Place, IEEE Spectrum, July 2003, p 26-30, the contents of which are incorporated by reference in its entirety.) That amounts to a total of 405 discrete component and 810 solder joints, each one subject to failure. In the U.S. alone, there were a trillion passive components installed in 2002, at an all-inclusive cost of $0.018 per component (cost of the component, assembly, testing, PCB footprint etc.) on average. Using the Nokia 6161 cell-phone as an example, the passives cost about $7.20 per cell-phone.

There are also limitations with respect to the construction of high specific capacity capacitors, such as Aluminum and Tantalum electrolytic capacitor, particularly when high specific capacity is needed. Also by way of example but not limitation, a 10 V, 10 μF Tantalum electrolytic capacitor for surface mount application is approximately 2*2*3.5 mm³. The specific capacity of said electrolytic capacitor is 7.1 VμF/mm³, and it will have about 1 μA leakage current after approximately 2 minutes of applying the rated voltage. Tan δ is 0.06. This electrolytic capacitor should endure approximately 2000 hours at 85° C. and at the rated voltage. The cost is about $0.10 each in a reel of 2000. A similar Aluminum capacitor will be 4*4*9 mm³. Its specific capacity is 0.7 VμF/mm³ and it will cost about $0.40. According to Frost & Sullivan market research estimates for the year 2006, the world market for Aluminum electrolytic capacitors is expected to be US $3.017 Billion and the world market for Tantalum electrolytic capacitors is expected to be US $5.252 Billion for a total of over US $8 Billion. This entire market could be replaced by sintered capacitors manufactured by ALD or a similar technology at a lower cost than electrolytic capacitors.

Catalyzers are used in the chemical industry to accelerate the rate of a chemical reaction. Catalyzers are commonly used in the petroleum industry, and the most common application is the catalytic converters that are used in motor vehicles to change the composition of exhaust gases. Ceramic structures, often coated with a thin layer of catalyst are used in the manufacturing of catalyzers. Some structures are made of wire mesh as a carrier for the catalyst. However, due to the high cost of most catalyst materials, including but not limited to rare and expensive materials such as platinum, rhodium and/or palladium, it is imperative to achieve maximum surface area of catalyst while minimizing the amount of catalyst in a catalyzer. The catalyst may currently be deposited on a substrate structure by CVD, electrochemically or by other processes. However, such processes deposit relatively thick layers, and have difficulties to penetrate the deep pores of the substrate material.

The following patent references are all incorporated by reference herein in their entireties: U.S. Pat. No. 5,222,366 issued to Yoder, entitled “Thermal Busbar Assembly in a Cryostat Dual Penetration for Refrigerated Superconductive magnets”; and U.S. Pat. No. 5,281,274 (“'274 Patent”) to Yoder, entitled “Atomic Layer Epitaxy (ALE) Apparatus for Growing Thin Films of Elemental Semiconductors.”

In one embodiment of the present disclosure, the construction and the process of manufacturing capacitors that may replace electrolytic capacitors is disclosed. According to this embodiment, the capacitors have one electrode made of sintered material, a dielectric layer formed by ALD technology, and a second electrode filled in the spaces between the sintered particles. According to one alternate embodiment, the capacitors may be high-capacitance type capacitors.

According to another embodiment, the construction of a high specific capacity (defined here as Volts*microfarads/mm³) capacitors is disclosed. Typically Aluminum and Tantalum electrolytic capacitors are used when high specific capacity is needed. However, these electrolytic capacitors have many drawbacks, including but not limited to high cost, short life (especially at elevated temperatures), high series resistance, energy losses due to ripple current that results in heating, inability to be used in AC applications, damaging failure mode (spreading of conductive electrolyte), bulky size, limited operational temperature range, high leakage current, capacitance dependent on how long the capacitor was under applied voltage, etc.

According to yet another embodiment, a method of manufacturing sintered capacitors using ALD is disclosed. These sintered capacitors will have fully monolithic structure, no leakage, no heat loss, low serial resistance and inductance, long life at elevated temperatures, induce no damage to the surrounding electronics upon failure and will be capable of full AC operation. The sintered capacitors manufactured according to this embodiment have a specific capacity, by way of example but not limitation, of 25 VμF/mm³-3.5 times higher then Tantalum capacitors, and 35 times higher then Aluminum capacitors. The sintered capacitors manufactured by this method are also disclosed in one embodiment of the present disclosure.

According to yet another embodiment, a catalyzer and method of manufacturing a catalyzer constructed of a porous material with the catalyst material deposited on the surface of the porous material by ALD technology is disclosed. The ALD process minimizes catalyst thickness while penetrating deep into the pores to achieve high surface area in the catalyzer.

According to another embodiment, an electrical component is disclosed that is manufactured according to the preceding method, and is comprised of:

a first electrode formed of sintered metal particles with less than a 100% fill ratio;

a dielectric layer, formed by ALD, wherein the dielectric layer substantially surrounds the first electrode; and

a second electrode formed in the remaining volume to complement to the first electrode and the dielectric layer and substantially completing the 100% fill ratio.

According to yet another embodiment, a component, such as a capacitor, resistor, catalyst or a battery electrode is disclosed, comprising:

at least one first conductive material; and

at least one second material formed about a surface of the at least one first conductive material by ALD.

It will be appreciated by those skilled in the art that the concepts presented herein are applicable for use with a variety of other microelectronic and electronic components other than those listed above and/or used in PCB assemblies, including low-capacitance capacitors, resistors, transducers, transformers, conductors, and batteries, to name a few. It is also to be understood that the present invention includes a variety of different versions or embodiments, and this Summary is not meant to be limiting or all-inclusive. That is, this Summary provides general descriptions of certain embodiments, but may also include more specific descriptions of certain other embodiments. For example, the concepts addressed herein are applicable to both the methods of manufacturing or constructing microelectronic and electronic components and sub-components, and to the components and sub-components manufactured by these methods as well. Furthermore, the use of the term component and/or sub-component is not intended to be limiting in any respect, and it is to be expressly understood that the methods of manufacturing and devices disclosed in varying embodiments herein may include complete, stand-alone devices, which are not dependent on other devices, such as with PCB or IC components.

Accordingly, various embodiments of the present invention are illustrated in the attached figures and described in the detailed description of the invention as provided herein and as embodied by the claims. It should be understood, however, that this Summary does not contain all of the aspects and embodiments of the present invention and that the invention as disclosed herein is and will be understood by those of ordinary skill in the art to encompass obvious improvements and modifications thereto.

Additional advantages of the present invention will become readily apparent from the following discussion, particularly when taken together with the accompanying drawings.

### BRIEF DESCRIPTION OF THE DRAWINGS

FIG. 1 is a perspective view of a capacitor deposited on a layer of PCB material according to one preferred embodiment of the present disclosure;

FIG. 2 is a partial perspective view of the capacitor shown in FIG. 1;

FIG. 3 is another partial perspective view of the capacitor shown in FIG. 1;

FIG. 4 is yet another partial perspective view of the capacitor shown in FIG. 1;

FIG. 5 is a perspective view of a resistor deposited on a layer of PCB material according to one preferred embodiment of the present disclosure;

FIG. 6 is a sectional view of a sintered capacitor manufactured according to one preferred embodiment of the present disclosure;

FIG. 7 is a partial sectional view of the sintered capacitor shown in FIG. 6;

FIG. 8 is another partial sectional view of the sintered capacitor shown in FIG. 6;

FIG. 9 is yet another partial sectional view of the sintered capacitor shown in FIG. 6;

FIG. 10 is yet another partial sectional view of the sintered capacitor shown in FIG. 6;

FIG. 11 is yet another partial sectional view of the sintered capacitor shown in FIG. 6;

FIG. 12 is yet another partial sectional view of the sintered capacitor shown in FIG. 6;

FIG. 13 is yet another partial sectional view of the sintered capacitor shown in FIG. 6; and

FIG. 14 is a partial sectional view of a catalyzer manufactured according to one preferred embodiment of the present disclosure.

The drawings are not necessarily to scale and may be exaggerated in some instances to emphasize certain portions of the present disclosure.

### DETAILED DESCRIPTION OF THE PREFERRED EMBODIMENTS

As discussed above, ALD is a manufacturing technique that allows one or more layers of atomic-scale precursor materials to be deposed on a surface, and has several benefits over other methods of manufacturing, including but not limited to operating at low pressures and temperatures, providing consistent and reliable atomic structures, and achieving uniform coating thickness at exposed and hidden surfaces that are not achievable with previous technologies. (See Appendix A to the U.S. Provisional Patent Application Nos. 61/028,383 and 61/028,402 for additional information on ALD technologies.) A typical ALD process may be summarized as comprising multiple cycles, with each cycle comprising two precursor stages (where two precursor materials are introduced) and two purge stages.

In the first precursor stage, the selected first precursor is introduced in to a reaction chamber for the purpose of reacting with a material. For example, Trimethyl Aluminum (TMA) may be used as a precursor for reacting with absorbed hydroxyl groups in a reaction chamber. (See Appendix A to the U.S. Provisional Patent Application Nos. 61/028,383 and 61/028,402.) The precursor stage continues until the surface of the material is passivated. Following the reaction of the precursor with the material, the first purge or evacuation stage is applied removing any excess precursor or undesired byproduct from the chamber.

In the second precursor stage, the selected second precursor is introduced into the reaction chamber. Continuing the example above, water vapor may be introduced to the chamber preferably by pulsing the water vapor directly on the material, in order to induce a reaction between the water vapor and the dangling methyl groups that exist on the layered surface of the material (as a result of the reaction between the TMA and the hydroxyl groups in the prior precursor stage). This reaction forms aluminum-oxygen bridges between the methyl groups, and further forms a new hydroxyl surface for a subsequent TMA precursor stage. After the second precursor element has been introduced and the surface has again passivated, the second purge stage is applied and the excess precursor is expelled from the reaction chamber. The completion of two precursor stages and two purge stages is referred to as one cycle.

An ALD process may comprise multiple cycles, some times on the scale of thousands, in order to form the desired thickness. As each layer is conformally and uniformly deposed on to the material surface and each preceding layer, the desired thickness may be accurately and consistently controlled by the number of cycles. The ALD process may be monitored and controlled by a number of known control logic hierarchies, such as PC-based, PLC (programmable logic controller) based, or by other control systems. (See Appendix A to the U.S. Provisional Patent Application Nos. 61/028,383 and 61/028,402.)

ALD may be used to deposit the insulating layer of a capacitor. A metallic layer will be deposited and patterned in a conventional way. Then an insulator layer will be deposited via ALD. A second metallic layer will then be deposited and patterned. Contacts to the patterned metallic layers will be made with common via technology. Using this ALD-manufactured capacitor as an example, several benefits may be observed, as shown from the following discussion.

Materials such as Al₂O₃, ZrO₂, HfO₂, SiO₂, SrTiO₃, BaTiO₃, Ta₂O₅, TiN, TaN etc. demonstrate that, when used in connection with ALD, high quality processes for deposition may be achieved. Each molecular layer is deposited in one cycle of the process, which takes approximately 0.5 to 5 seconds depending on the specifics of the ALD process. One molecular layer has a thickness of ˜0.085 nm (0.85 Å) for Al₂O₃. By way of example but not limitation, an assumption is made that the dielectric layer of Al₂O₃ has a thickness of 10 nm. To reach this assumed thickness of 10 nm, 120 layers need to be deposited. According to one embodiment of the present disclosure, the ALD process will take approximately 60 to 600 seconds. The process is done at low pressure and relatively low temperature of 100-200° C. (Deposition of Al₂O₃ on Silicon wafer is usually done at 300° C., and this is the only major difference between the process for PCBs and the process for Silicon substrate).

The ALD deposited Al₂O₃ has dielectric constant of approximately 8. Calculation of the capacity of 1 cm² of a capacitor made of a 10 nm thick layer of Al₂O₃ between two metallic electrodes is as follows:

C=εₒ*εᵣ*A/d εₒ=1/(36*π*10⁹)

Where A is the area in m² and d is the insulation thickness in meters. C will be in Farads.

C=(1/(36*π*10⁹))*8*1*10⁻⁴/10*10⁻⁹=7*10⁻⁷=0.7 μF

Therefore a capacity of 0.7 μF/cm² can be achieved.

The dielectric breakdown voltage of Al₂O₃ is 8-10 Mv/cm. Taking 8*10⁸ V/m:

V=10*10⁻⁹* 8*10⁸=8 V

Using a voltage level of half of the breakdown, a useful operational voltage of 4V is therefore reasonable.

For applications requiring higher voltage, a capacitor specified for 10 Volt with 0.28 μF/cm² could be deposited with 300 layers of Al₂O₃. As one of ordinary skill in the art will appreciate, the material and the number of layers may be varied to achieve a wide range of capacitance and voltages for such a capacitor.

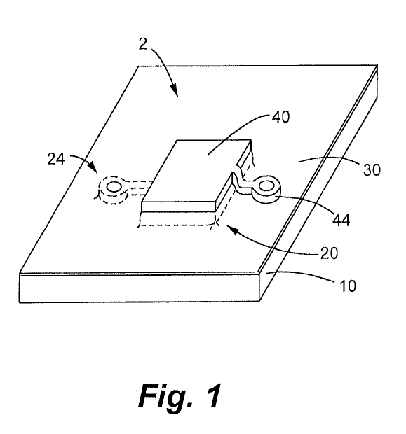

Referring now in detail to the drawings (FIGS. 1-14), various embodiments of the present disclosure are described. Referring in detail to FIG. 1, a PCB deposited capacitor 2 is shown, comprising a substrate 10, which is comprised of a PCB substrate layer 10 that supports a top electrode 40 and bottom electrode 20 that make up the capacitor 2. The bottom electrode 20 further comprises a bottom contact 24, and the top electrode 40 comprises a top contact 44. The assembly of FIG. 1 further comprises a layer of ALD deposited dielectric 30 separating the top 40 and bottom electrodes 20 of capacitor 2.

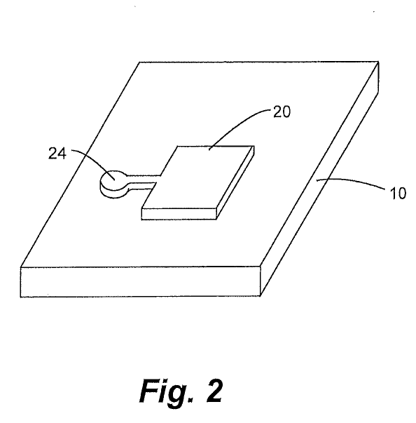

Referring now to FIGS. 2-4, the structure of the capacitor 2 will be explained with the aid of drawings showing the construction steps. Referring in detail to FIG. 2, the PCB substrate layer 10 is shown with the bottom electrode 20 and contact 24 deposited thereon. The bottom electrode 20 and contact 24 may be made of variety of materials, including by way of example but not limitation, the following: Nickel, Tungsten, Copper, etc. or metallic composition. The bottom electrode 20 and contact 24 may be deposited using electro-less plating, sputtering, evaporation coating or other suitable processes, and may be patterned while being deposited with processes such as sputtering or evaporation coating through a mask. Alternatively, the bottom electrode 20 and contact 24 may be deposited on the whole PCB substrate layer 10, and then the unwanted areas etched away using common PCB manufacturing processes. In yet another alternative embodiment, the bottom electrode 20 and bottom contact 24 may be deposited separately and then soldered or connected using other known, suitable methods for such connection. The area shown in FIG. 2 as bottom electrode 20 will be the capacitor's first electrode, while the bottom contact 24 provides an area for drilling a via hole to electrically connect to the bottom electrode 20 through the dielectric layer 30 shown in FIG. 1.

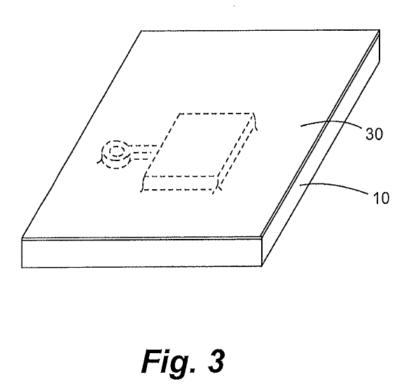

Referring now to FIG. 3, an ALD-deposed dielectric layer 30 is shown deposited on the bottom electrode 20, bottom contact 24 and the PCB substrate layer 10. In this step, ALD deposition of the dielectric layer 30 occurs on the whole surface area of the PCB substrate layer 10, including the bottom electrode 20 and contact 24. This ALD deposition of a dielectric material coats the bottom electrode 20 and the exposed PCB substrate layer 10 with a dielectric layer 30 for providing the dielectric layer of the capacitor. Many dielectric materials are suitable, by way of example but not limitation, cIn one embodiment, the dielectric layer 30 is visibly transparent (Al₂O₃, SiO₂, etc.) and the bottom electrode will be visible, although in FIG. 3 the bottom electrode 20 and bottom contact 24 are shown dashed for purposes of clarity. The conformity and uniformity of the coating achievable by ALD technology is enabling the manufacturing of the capacitor 2, as other deposition technologies such as CVD will crate a layer 30 that may have voids or that do not conform to surface irregularities of the surface of the bottom electrode 20 and causes a short circuit when the top electrode is deposited.

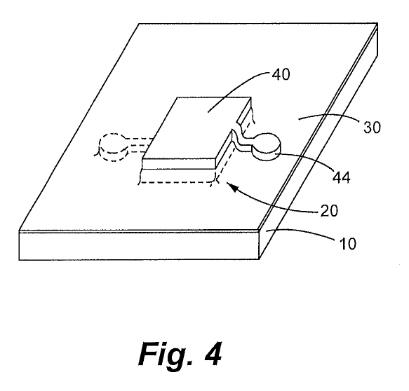

Referring now to FIG. 4, the top electrode 40 and top contact 44 are shown deposited on the dielectric layer 30 and top electrode 40 is directly above bottom electrode 20. In this step, the top electrode 40 is deposited on top of the dielectric layer 30 by known methods, such as electro-less plating, sputtering, evaporation coating or other suitable processes, and may be patterned while being deposited with processes such as sputtering or evaporation coating through a mask. Alternatively, the top electrode 40 and contact 44 may be deposited on the whole dielectric layer 30, and then the unwanted areas etched away using common PCB manufacturing processes The top electrode 40 surface area is approximately the same as the surface area of the bottom electrode 20 for placing the top electrode 40 directly above the bottom electrode 20. This results in maximizing capacity while minimizing space taken on the PCB substrate layer 10. The top contact 44, although depicted in FIG. 4 as being positioned at the opposite pole of the bottom contact 24, may be positioned at any location on the PCB substrate layer 10, but not above the bottom contact 24 or the bottom electrode 20. This is so via holes through top contact 44 and bottom contact 24 may reach the contacts separately and independently.

The structure in FIG. 4 is then laminated with the other layers of the PCB (not shown). After lamination, via holes are drilled to reach the contacts and to make electrical connections, as commonly practiced in PCB manufacturing. Via holes are exaggerated in FIG. 1, and are preferably located in the center of the distal ends of top and bottom contacts 24, 44. The structure of FIG. 4 may alternatively be coated with conformal plastic material to protect it until lamination with the other layers of the PCB.

The drawings in FIGS. 1-4 are not to scale, to make easy visualization of the structure. Thickness of the PCB substrate layer 10 may be on the order of hundreds of micrometers, the top and bottom electrodes 20, 40 may be few micrometers thick and the dielectric layer 30 is on the order of tens of nanometers thick. After the dielectric layer 30 is deposited, it will be difficult or impossible to visibly distinguish the structure from before deposition, due to the minute thickness of the dielectric layer 30.

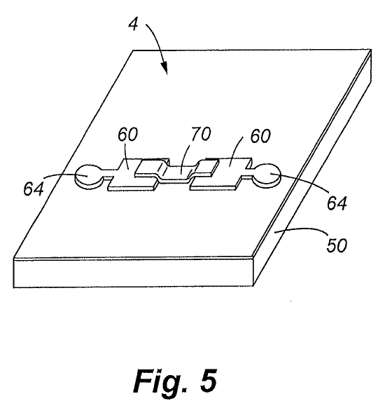

Deposition of metals such as W or conducting molecules by ALD technology is also practiced. ALD will enable deposition of resistors on PCBs to complement the capacitors deposition described herein. According to one embodiment of the present disclosure, a resistor is formed using ALD to form at least one resistive element of said resistor. Referring now to FIG. 5, such a resistor formed by ALD is shown. Resistor 4 is comprised of resistive material 70, pads 60 and contacts 64 deposited on a PCB substrate layer 50. In a preferred embodiment, the resistive material 70 may be comprised of any composition of metals or non-metals that have the required resistivity (resistivity is commonly measured in Ohms per mm² per meter). The resistivity and dimensions of the resistive material 70 define the resistance of the resistor 4. The resistive material 70 is deposited by ALD process described above, enabling low temperature deposition of a well-defined resistive element, and then patterned by etching away the unwanted areas as required. Laser trimming may be used to adjust the resistance.

The contacts 64 and pads 60 are normally much thicker then the resistive material 70, on the order of 1-20 microns. The greater thickness aids in connecting to the contacts 64 with via holes. The pads 60 and contacts 64 are preferably made from highly conductive metal, such as Copper, Nickel, etc., and may be deposited by known and/or standard processes in PCB manufacturing. The pads 60 and contacts 64 are shown in FIG. 5 as being placed on the PCB before the resistive material 70 is deposited, but in one alternative embodiment the resistive material 70 is placed first with deviating from the spirit of the present disclosure.

According to one embodiment, the resistor 4 of FIG. 5 may further comprise additional resistive elements other than resistive material 70. According to yet another embodiment, multiple resistors may be deposited on a single PCB substrate layer 50, either in a single ALD process step as described above followed by etching away the unwanted areas, or in separate ALD process steps to form two or more resistive materials 70 on the PCB substrate layer 50.

Where trimmer capacitors are currently in use, capacitors may be deposited on exposed layers of the PCB, top or bottom, and be laser trimmed. The trimming is done by cutting away parts of the capacitor with a laser beam, to change the capacitance. It is normally done while the capacitance is continuously measured to achieve accurate results. Where trimmer resistors (potentiometers) are currently in use, resistors may be deposited on exposed layers of the PCB, top or bottom, and be Laser trimmed.

As discussed previously, ALD occurs preferably in a reaction chamber. A fully automated system for the deposition of materials described herein, and in the example of deposing Al₂O₃ on PCB may be constructed for under US $1 Million per chamber. A chamber with 500 mm×500 mm capacity is capable of coating a PCB with these dimensions in less than 2-11 minutes (60-600 seconds for deposition and 30-45 seconds for insertion and removal).

Returning to the example of a Nokia 6161 cell-phone, the PCB is 40 Cm² per phone, or about 50 phones per panel with 500 mm×500 mm dimension. The cost/phone for manufacturing capacitors and resistors onto the PCB according to the present invention will be approximately $0.13-0.50. Additional costs for the deposition and patterning of the metal electrodes may increase the total cost in the range of $0.60-0.80. Assuming that the deposited capacitors will replace 200 of the 232 capacitors in the Nokia 6161, the savings will be approximately $2-3 per phone. (Average total cost of a passive discrete component is $0.018 per component and 200 capacitors will cost about $3.60).

Other benefits besides cost are apparent from observing the ALD manufactured battery electrodes, capacitors, resistors and other components. ALD deposition of capacitors will nearly halve the manufacturing time on the pick-and-place tool, allowing for the production of more cell-phones (or other devices) on the same infra-structure. A fast pick-and-place tool can place 10,000 components per hour. Such a tool will assemble approximately 25 Nokia 6161 cell-phones per hour, but can assemble twice this number if most capacitors and resistors are deposited by ALD. One ALD tool could save the need for about 5-30 pick-and-place tools, thereby changing the production process from serial to parallel, and increasing throughput.

The saving of 200 capacitors and resistors will reduce the number of failure points in the cell-phone by 400 solder joints and 200 components, a total of 600 possible failure points. About 400 vias will be added, but vias have higher intrinsic reliability then components or solder joints. Testing of the embedded capacitors and resistors will be performed on a board level, before assembly of component. This will allow for earlier weeding away of faults. Together with the higher reliability of vias compared with solder points, a higher production yield will ensue.

The Al₂O₃ example of ALD technology described above also has a benefit in that it produces nearly zero hazardous emissions. The deposition of Al₂O₃ produces insignificant amounts of CO₂ as the only by-product, in addition to the completely inert Al₂O₃. The deposited Al₂O₃ is absolutely non-toxic, compared with the toxicity of the lead or other materials in solder joints. The recycling of used PCBs will be easier with less lead.

In some applications where ceramic substrates are now in use, such substrates could be replaced with Kapton® or FR4 based PCBs due to the ability to deposit capacitors at lower temperatures. This will be important in the high-end applications that now require the use of high cost ceramic substrates. Furthermore, the reduced weight of the components is important in spacecraft and aircraft applications.

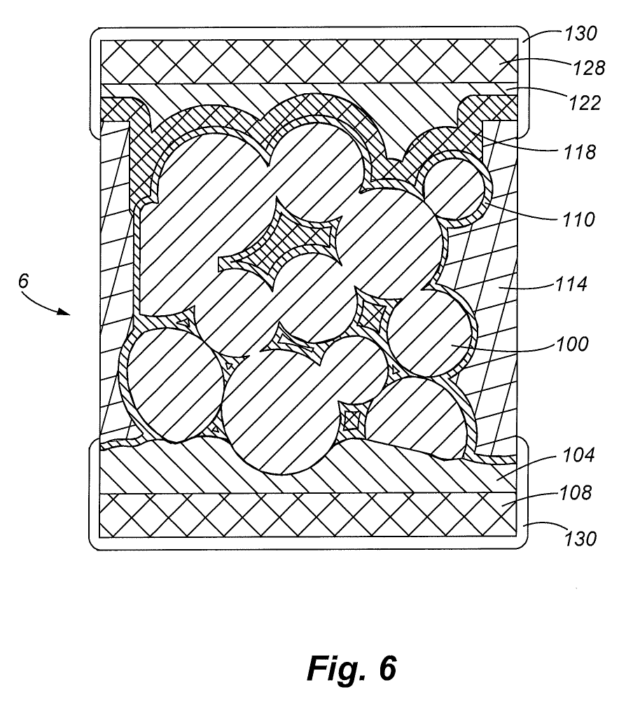

According to another embodiment, a method of manufacturing sintered capacitors by ALD is disclosed. A sintered capacitor manufactured by ALD according to one embodiment is shown in a cross-sectional view in FIG. 6. It is important to note that the drawing of FIG. 6 is not to scale, as the whole structure is on a scale of millimeters while the spherical sintered particles are on a scale of micrometers. The sintered capacitor 6 is comprised of sintered material 100. In a preferred embodiment, the sintered material 100 also acts as one of the electrodes of the sintered capacitor 6, and is preferably made of conductive powder. Particle diameter between 0.1 μm and 10 μm is common in sintering metals, however for calculation purposes, by way of example but not limitation, it is assumed to be 1 μm particles. The outer surface of the sintered material 100 is coated by dielectric material 110 deposited by ALD, according to methods described above and further shown in Appendix A to the U.S. Provisional Patent Application Nos. 61/028,383 and 61/028,402. The complement vacant space left by the sintered material 100 and dielectric material 110 is filled with an electrode material 118, that preferably is made of conductive material. The electrode material 118 may be formed by an ALD process, or according to one alternative embodiment by other processes, like wetting with molten metal. In a preferred embodiment, the sintered material 100 and the electrode material 118 are connected to electrical contacts 108, 128 by brazing 104, 122. In an alternate embodiment, the sintered material 100 and electrode material 118 are connected to the contacts by soldering. Proper insulation 114 is preferably added to minimize the possibility of shorts at the outer surfaces.

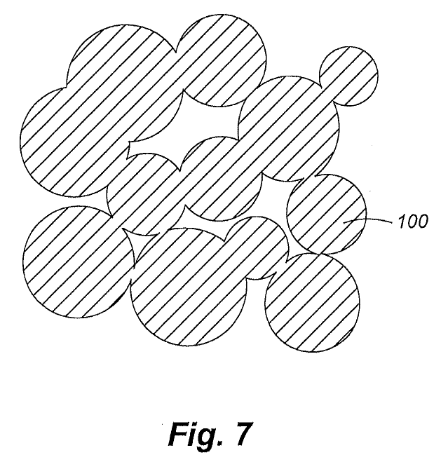

The detailed construction of the sintered capacitors will be better understood by the description of the construction process described in relation to FIGS. 7-13. Referring now to FIG. 7, the sintered material 100 is shown in cross-sectional view as a sintered powder. The construction of the sintered capacitor 6 starts with creating the sintered material 100 to form an electrode by sintering of metal powder. It is preferred that conductive metals such as Copper, Silver, Nickel, stainless steel, etc. are used. In one alternative embodiment, metal compositions and/or metal particles coated with the same or another metal are used. In another alternative embodiment, non-metals, such as ceramics may be used if coated with metals either before or after sintering. During the sintering process of the preferred embodiment, the metal powder is pressed and heated to a temperature below the melting point of the material, causing localized merger of the particles. In FIG. 7, spherical shaped particles are shown, but other shapes are possible. The particles may be solid as shown in FIG. 7, or may be porous, depending on the material and the technique employed. The particles may have very uniform size or varieties of sizes. While the sintered body may have any shape or size, cubical or spherical shaped bodies from 1 mm in size to 10 mm in size are preferred. The sintered body should have about 50% fill ratio, but other fill ratios may be used according to the known sintering processes. For example, if 1 micron cubic particles are used, a cube of 2*2*2 mm³ dimension will have approximately 4*10⁹ particles at a fill factor of 50%, with total surface area of 24,000 mm². (Cubes are used here, by way of example but not limitation, for simplicity of calculation.) For other situations the numbers may differ according to the material structure. The sintering process results in forming an electrode comprised of the sintered material 100.

According to yet another alternative embodiment, any porous material that was made by a variety of technologies may be used for the first electrode. Some porous materials have very large surface area that will be useful in creating large capacity. If not conducting, the material may be coated with at least one conducting layer.

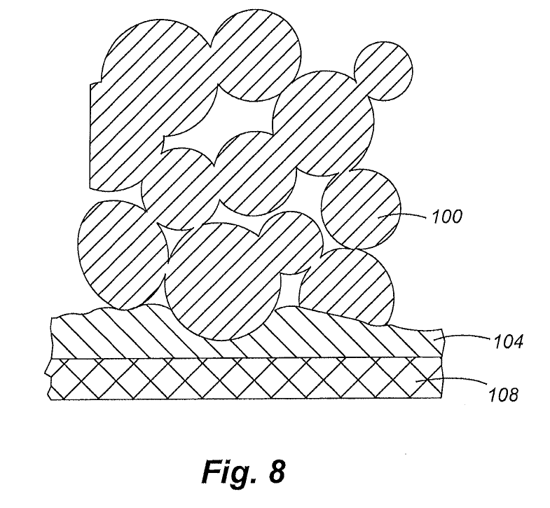

Referring now to FIG. 8, the bottom contact 108 is preferably formed of convenient or common conductive metal, and is brazed 104 to the sintered material 100. In mass production, the bottom contact 108 will be formed from a piece of sheet metal onto which thousands of cubes of sintered material 100 are brazed. The cross-sectional view of only one cube is shown in FIG. 8 for clarity. By way of example but not limitation, common dimensions include a bottom contact of approximately 0.5 mm thickness and 300*300 mm² width and length, on to which 10,000 cubes of 2*2*2 mm³ are brazed at a pitch of approximately 3 mm. Apart from brazing 104, other forms of connection between the sintered material 100 and the bottom electrode 108 are possible, such as soldering, another step of sintering, or sintering the sintered material 100 while directly in contact with bottom contact 108.

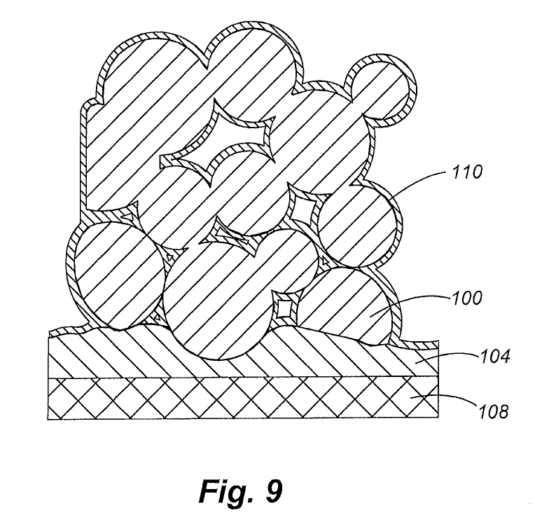

Referring now in detail to FIG. 9, an ALD dielectric material layer 110 formed on the sintered material 100 is shown in cross-sectional view. In this step, ALD is used to form the dielectric material layer 110 surrounding the electrodes formed from the sintered material 100. ALD is specifically useful in this step, as it enables deposition of very well conformed layers of material into very deep cavities. The process, as explained above, is self-terminating to create one molecular layer in each cycle of the process. According to a preferred embodiment, the dielectric material layer 110 should have high dielectric constant and high dielectric strength. A known material in such ALD applications is Al₂O₃, used as an example above and below. In alternative embodiment, other dielectrics such as, by way of example but not limitation, ZrO₂, HfO₂, SiO₂, SrTiO₃, BaTiO₃, TiN, TaN or Ta₂O₅ may be used.

Using Al₂O₃ as an example, this material has a dielectric constant of approximately 8 and breakdown voltage of between 8-10 MV/cm. Assuming, by way of example but not limitation, that the objective is to manufacture a capacitor with 10 V operational voltage, and it is desired to have approximately 4 MV/cm or 4*10⁵ V/mm as the working voltage. For a 10 Volt operational capacitor, the dielectric thickness is calculated as follows:

T=10/4*10⁵=2.5*10⁻⁵ mm or 25 nm

Each molecular layer of Al₂O₃ is ˜0.085 nm in thickness. Therefore, approximately 300 layers are needed for dielectric layer 110. For different operational voltage the thickness changes nearly linearly.

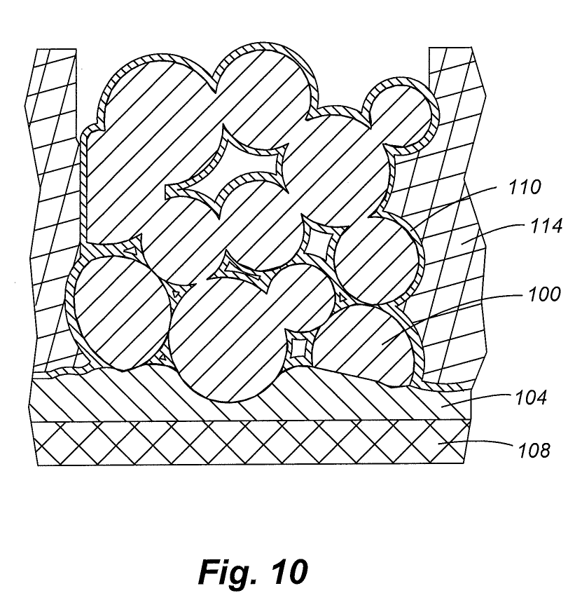

Referring now to FIG. 10, the next step is of adding insulation 114 on the sides of the dielectric material layer 110 coated sintered material 100. The reason for the insulation 114 is primarily that to place the electrode material 118, it is undesired to create a periphery of the component where the two electrodes (sintered material 100 and electrode material 118) are separated by only a few nanometers. According to a preferred embodiment, the insulation 114 is comprised of a thermosetting plastic or thermoplastic material with a high melting temperature. Alternatively, glass insulation may be used as a substitute to plastic material, consisting of various kinds of glass materials. The insulation 114 may be structured as powder, a paste, or pre-formed material to fill in among the cubes of individual capacitors units and then set or re-flowed. The insulation 114 must be viscous enough not to fill in the bulk of volume between the sintered particles

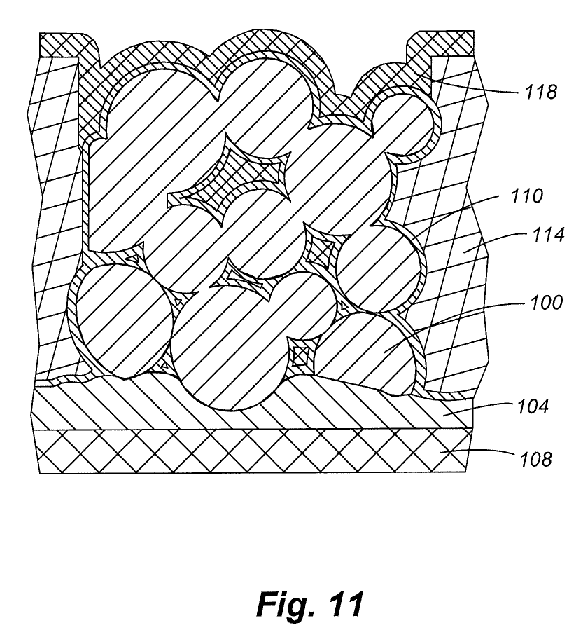

Referring now to FIG. 11, a cross-sectional view of the sintered capacitor assembly is shown including the second electrode. In this step, ALD deposition of the electrode material 118 occurs. While ALD of metal conductive material is preferred, other technologies may be used to complete this step. Molten metal under vacuum conditions may be used to create the electrode material 118. A combination of first coating one metal that adhere well to the dielectric material layer 110 and then melting-in another metal may also be used. In such a case, the ALD deposited layer will help the molten metal to wick in.

Metallic ALD may need substantial number of layers to fill in (up to several thousands) all spaces formed between the sintered material 100 areas. In an alternative embodiment, certain spaces may be blocked-off (by inserting additional material to bridge any open voids) and left unfilled, so long as all voids are blocked. The electrode material 118 is preferably deposited at a temperature that does not melt the insulation 114. According to one alternative embodiment, the electrode material 118 may be used as the top contact or another layer of material may be used as top contact as will be shown below.

Once the electrode material 118 is in place, the construction of the sintered capacitor 6 is complete. The capacity of a parallel-plate capacitor is calculated as follows:

C=εₒ*εᵣ*A/d where: εₒ=1/(36*π*10⁹)

Where A is the area in m² and d is the insulation thickness in meters. C is in Farads.

For the example capacitor described above:

A=24,000 mm² or 24*10⁻³ m²

D=25 nm or 25*10⁻⁹ m

εᵣ=8 for Al₂O₃

C=εₒ*8*24*10⁻³/25*10⁻⁹=68 μF

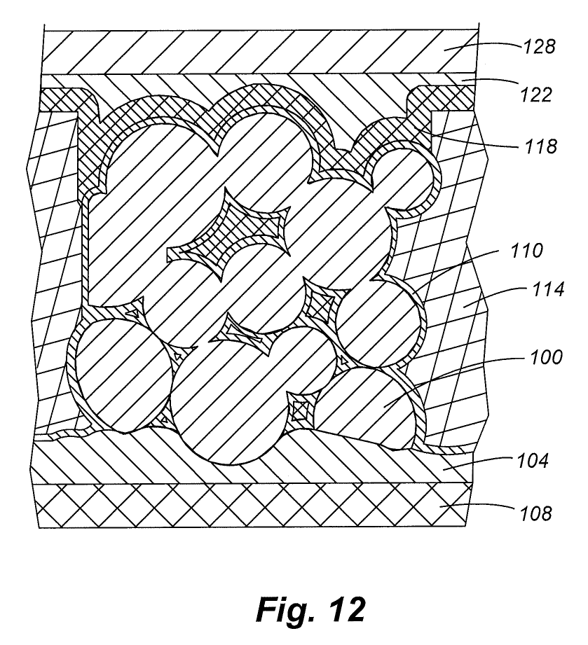

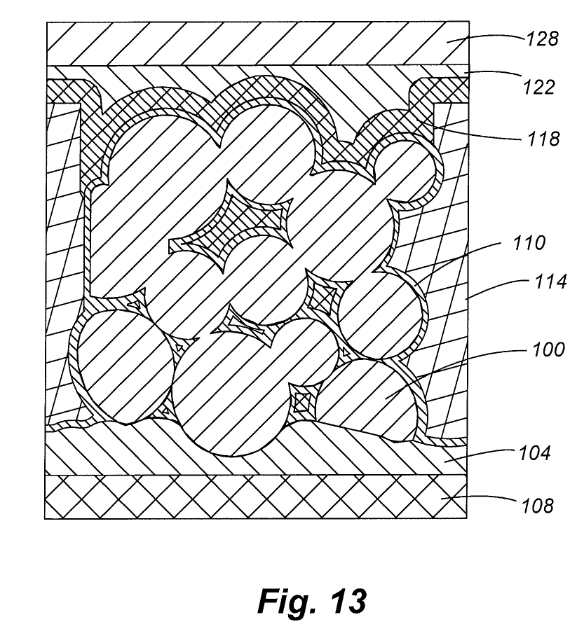

Referring back to the drawings, reference to FIG. 12 is now made. The next step is of placing the top contact 128. As seen in FIG. 12, the top contact 128 is preferably brazed 122 to the electrode material 118. The top contact 128 will preferably have the same dimensions as the bottom contact 108, and will be brazed 122 to all the capacitor cubes at once. Brazing 122 may be performed under a vacuum. After this step, the individual sintered capacitors 6 may be formed by sawing the structure in the middle of the insulation in two directions, as depicted in FIG. 13.

A solder barrier 130 may be applied to the top 128 and bottom contact 108, as shown in FIG. 6, and this solder barrier 130 may be coated with solder material to prepare for assembly. In an alternative embodiment, laser marking may be applied. The manufacturing process described in various embodiments above results in the final component as shown in FIG. 6. The whole unit may be placed in a tape package for automatic assembly.

The completed sintered capacitor 6 of the example will have dimension of about 3*3*3=27 mm³. The specific capacitance will be:

68*10/27=25 VμF/mm³

Comparing to typical Tantalum electrolytic capacitors at 7.1 VμF/mm³, and typical Aluminum electrolytic capacitors at 0.7 VμF/mm³ suggests vast improvements over present technology methods of manufacture. Due to the construction of the sintered capacitor, having a high quality dielectric material, compared with electrolytic capacitors where the dielectric is made of electrically created oxides that have many deficiencies, it is expected that sintered capacitors will fully displace the electrolytic capacitors in the marketplace. The higher specific capacity will only add to the displacing force. The specific capacitance of the above discussion is an example only, and different sized and shaped powder, as well as different sintering process used for making the sintered material will vary the capacitance substantially.

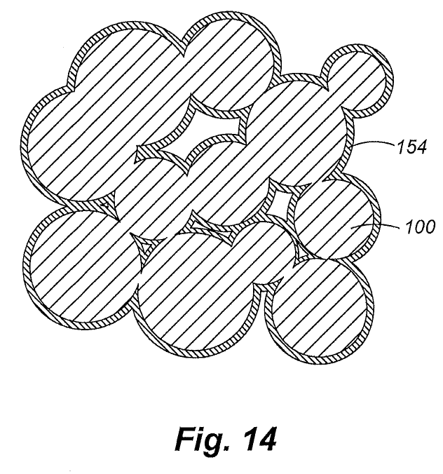

According to yet another embodiment of the present disclosure, a catalyzer may be formed using ALD as described in greater detail in the following paragraphs. Referring now to FIG. 14, the structure of the catalyzer is shown in a cross-sectional view. In FIG. 14, the substrate 150 is shown as made of sintered material that was made of nearly spherical particles. However any suitable sintered material or porous material may be used. Also, wire mash or any similar structure may be used as the substrate. The substrate 150 function is to carry the catalyst 154 on its surface. Large surface area of a substrate 150 in a relatively small volume is preferred.

The catalyst 154 is preferably deposited by ALD as described in various embodiments herein (See above and Appendix A to the U.S. Provisional Patent Application Nos. 61/028,383 and 61/028,402). The benefit of ALD in catalyst deposition is its ability to deposit atomic or molecular layers that penetrate deep into the pores of the substrate. Typically, catalyst materials are quite expensive, and only the surface area of the catalyst is useful in catalyzing a chemical reaction. Therefore, a thin layer is a major benefit. ALD technology permits deposition of a few or single atomic or molecular layers or layer of catalyst 154 on the substrate 150. More then one layer may be needed if the catalyst 154 is eroded or lost in other processes during the life of the catalyzer. However, for many applications, less then 100 atomic or molecular layers will suffice. By way of example but not limitation, automotive catalytic converters often include catalyzer materials that are expensive (several hundred dollars of worth of catalyst are used in each). An ALD process of depositing the catalyst reduces this cost dramatically.

The same ALD process may also be used in the manufacture of batteries, and more specifically battery electrodes. Traditionally, battery electrodes are created by covering a carbon structure with some sort of catalyst (for example, via CVD process). While the CVD process is useful in quickly creating battery electrodes, the non-uniformity of the layers deposited on the carbon structure and the fragility of the carbon structure can lead to the catalyst chipping off of the electrode, thereby rendering the battery inoperable. With ALD, the variation in thickness of each of the layers of catalyst vary by less than about 5% of the overall thickness of any single catalyst layer. Embodiments of the present invention may be employed to create a battery electrode by first providing a structure of sintered material (e.g., steel, brass, bronze, etc.) for the shape of the battery electrode. Then an ALD process may be utilized to coat the sintered material with platinum, rhodium, palladium, and/or some other catalyst. Accordingly, a more durable battery can be created at a lower cost since the sintered material is used to replace the carbon structure.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

While various embodiments of the present invention have been described in detail, it is apparent that modifications and adaptations of those embodiments will occur to those skilled in the art. However, it is to be expressly understood that such modifications and adaptations are within the spirit and scope of the present invention, as set forth in the following claims.

What is claimed is:

1. An electrical capacitor comprised of:
a first electrode formed of porous material with less than a 100% fill ratio;
a dielectric layer that substantially surrounds the first electrode; and
a second electrode formed in the remaining volume to complement the first electrode and the dielectric layer.

2. The electrical capacitor according to claim 1 where the dielectric layer is manufactured by Atomic Layer Deposition.

3. The electrical capacitor according to claim 1 wherein the first electrode is formed of sintered metal particles.

4. The electrical capacitor of claim 1 wherein the electrical capacitor further comprises at least one insulation layer formed proximate to the periphery of the electrical capacitor to separate the first and second electrodes.

5. A method of manufacturing an electrical capacitor by:
forming a first electrode of porous material with less then 100% fill ratio;
depositing a dielectric layer by Atomic Layer Deposition, wherein the dielectric layer substantially surrounds the first electrode; and
forming a second electrode that complements the first electrode and the dielectric layer.

6. The method of claim 5 wherein the step of forming a first electrode of porous material comprises forming of a first electrode of sintered particles.

7. A component comprising:
at least one first conductive material formed on a surface of a Printed Circuit Board; and
at least one second material formed about a surface of the at least one first conductive material by Atomic Layer Deposition.

8. The component of claim 7 wherein the component is a capacitor, the capacitor comprising a dielectric layer as the at least one second material.

9. The component of claim 7 wherein the component is a resistor, the resistor comprising a conductive layer as the at least one second material.

10. An catalyzer comprised of:
a porous body with less then 100% fill ratio;
a catalyst layer that substantially surrounds the first electrode; and
wherein the catalyst layer is manufactured by Atomic Layer Deposition.

11. The catalyzer of claim 10, wherein the porous body is formed of sintered particles.

12. An battery electrode composed of:
a sintered body formed of sintered particles with less then 100% fill ratio; and
a layer that substantially surrounds the first electrode where the layer is manufactured by Atomic Layer Deposition.
